(19) United States
(12) Patent Application Publication
(10) Pub. No.: US 2017/0231430 A1
(43) Pub. Date: Aug. 17, 2017

(54) Air Fryer

(71) Applicant: NuWave, LLC, Libertyville, IL (US)

(72) Inventors: Jung S. Moon, Long Grove, IL (US); Eunjung Huh, Gurnee, IL (US)

(21) Appl. No.: 15/431,333

(22) Filed: Feb. 13, 2017

Related U.S. Application Data
(60) Provisional application No. 62/294,616, filed on Feb. 12, 2016.

(51) Int. Cl. A47J 37/12

(52) U.S. Cl. CPC A47J 37/1266; A47J 37/1257; A47J 37/1295; A47J 37/1276

(57) ABSTRACT

An air fryer system is disclosed which comprises a base having a heating source and an air source located therein, both sources being supplied power for operation by an AC power cord. A cooking chamber is defined within the base and a cooking drawer fits securely within the cooking chamber to substantially seal the chamber against heat loss during use. A handled food basket which detachably secures to the cooking drawer is configured to facilitate even distribution of heated air within the cooking chamber. A digital, touch screen user interface attached to a surface of the base is electronically coupled to a controller for powering on the fryer system and setting cooking conditions. The preferred system also includes infrared heating, time and temperature controls, and an automatic safety shutoff mechanism.

### RELATED APPLICATION

The present application claims the filing priority of U.S. Provisional Application No. 62/294,616, titled “AIR FRYER” and filed on Feb. 12, 2016. The '616 Provisional Application is also incorporated herein by reference.

### TECHNICAL FIELD OF THE INVENTION

The present invention relates to air fryers. More specifically, the invention relates to an air fryer with safety features and infrared heating elements.

### BACKGROUND OF THE INVENTION

An air fryer is a kitchen appliance that cooks by rapidly circulating hot air around food within a basket in a cooking chamber. Some air fryers may come with adjustable temperature and timer knobs that allow for more precise cooking. A mechanical fan circulates the hot air around the food at high speed, cooking the food and producing a crispy layer thanks to Maillard reactions.

By circulating air at temperatures of up to 200° C. (about 392° F.), the air fryer is able to fry foods like potato chips, chicken, fish, pastries and more using much less oil than a traditional fryer. Various brands of air fryers claim to use as much as 80% less cooking oil in comparison to traditional fryers.

Also, by using less oil to fry, air fryers become a healthier alternative to traditionally deep fried foods. Reports show that deep frying foods can increase the risk of cardiovascular diseases, hypertension, diabetes, cancer and obesity. Some people are concerned that this healthier form of cooking will result in poorer taste, look and texture of traditional recipes. However, a study published in the Journal of Food and Nutrition Sciences show that fries which were cooked using an air fryer actually beat traditionally deep-fried potatoes in taste, color, smell, crispness, hardness, oiliness and were rated worse than traditional deep-fried potatoes only in appearance.

However, air fryers aren't without disadvantages. For example, unlike some deep fryers, air frying must occur in a closed space for temperature control. This can make the monitoring of cooking foods in an air fryer difficult. Further, unlike deep fryers, which immerse foods into hot oil, air fryers rely on the movement of heated air. Having adequate channels to move this air through the cooking space so that it achieves an optimum heat distribution has been a challenge for air fryer manufacturers. Improper heat distribution results in foods with overcooked and undercooked portions. Of course, operating at such high temperatures can create safety issues, as well. Especially in the case of overheating of the fryer.

Until the invention of the present application, these and other problems in the prior art went either unnoticed or unsolved by those skilled in the art. The present invention provides an air fryer which performs multiple functions without sacrificing quality, reliability, design or affordability.

### SUMMARY OF THE INVENTION

There is disclosed herein an improved air fryer system which avoids the disadvantages of prior devices while affording additional structural and operating advantages.

Generally speaking, the air fryer system comprises a base having a heating source and an air source located therein, with both sources preferably being supplied power for operation by an AC power cord. The fryer also includes a cooking chamber defined within the base, a cooking drawer which fits securely within the cooking chamber and substantially seals the chamber against heat loss during use, a handled food basket which detachably secures to the cooking drawer, an electronic controller within the base for controlling at least the heating source, the air source and the power source and user controls attached to the base for powering on the fryer system and setting cooking conditions.

In specific embodiments of the system, the food basket locks into the cooking drawer and has a latch for removing the basket, as desired. A guard positioned over the latch may be used to cover the latch and protect against accidental unlocking of the food basket.

In other specific embodiments, a divider may be positioned within the food basket. The heating source will preferably be comprised of an infrared heating source. The user interface may comprise programmable time and temperature buttons, as well as a plurality of preset time and temperature settings and a plurality of programmable buttons.

In preferred embodiments, a safety switch is used to electronically couple to the controller and shut off the heating source when the cooking drawer is opened.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of a preferred embodiment of the disclosed air fryer system with an open cooking drawer;

FIG. 2 is a perspective view from another side of the embodiment of the disclosed air fryer system of FIG. 1;

FIG. 3 is a side view of the embodiment of the air fryer system shown in FIG. 1;

FIG. 4 is a rear view of an embodiment of the disclosed air fryer system;

FIG. 5 is another side perspective view of the embodiment of FIG. 1 with the cooking drawer in an open position;

FIG. 6 is a close up front view of an embodiment of the cooking chamber with the cooking drawer removed;

FIG. 7 is a top view of the removed cooking drawer including the food basket;

FIGS. 8 and 9 are views of a heating source and air source positioned within the cooking chamber of the air fryer system of FIG. 7;

FIG. 10 is a top view illustrating a latch on the handled food basket secured within the cooking drawer;

FIG. 11 is a top view of the cooking drawer with the handled food basket removed;

FIGS. 12 and 13 are views of the handled food basket of FIG. 10;

FIG. 14 is an embodiment of a list of food items with cook times and temperatures;

FIG. 15 is an embodiment a user interface and display of the disclosed air fryer system;

FIG. 16a is an illustration of the cooking process within the cooking chamber showing heated air flow patterns;

FIG. 16b is a close up view of the bottom of the cooking drawer with arrows illustrating heated air flow directions; and

FIG. 17 is a chart illustrating the temperature accuracy of the present system over prior art systems.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

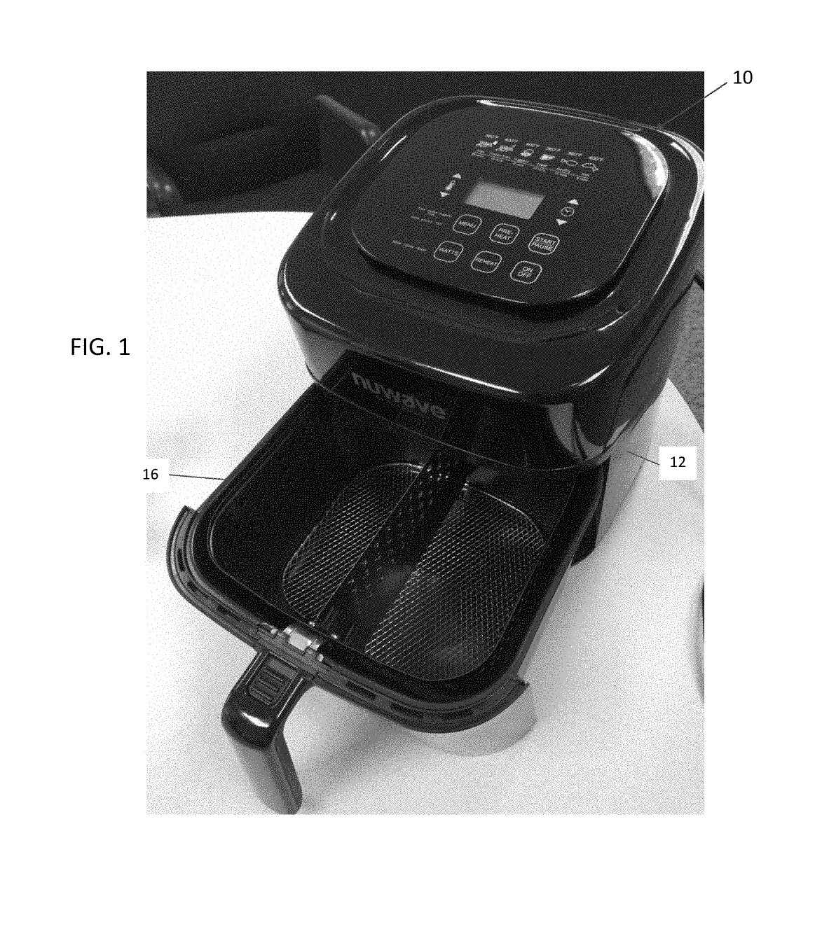

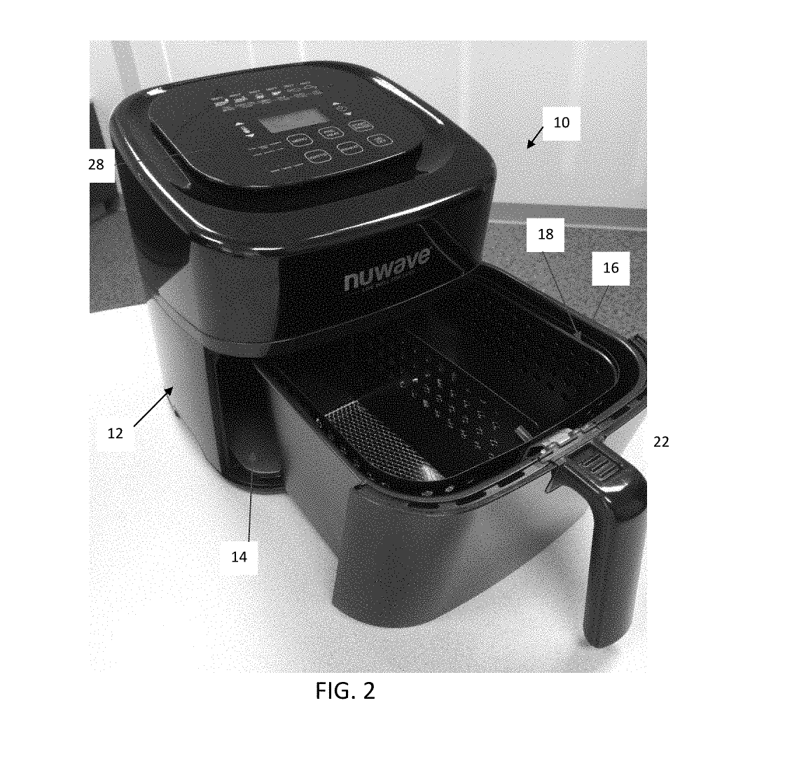

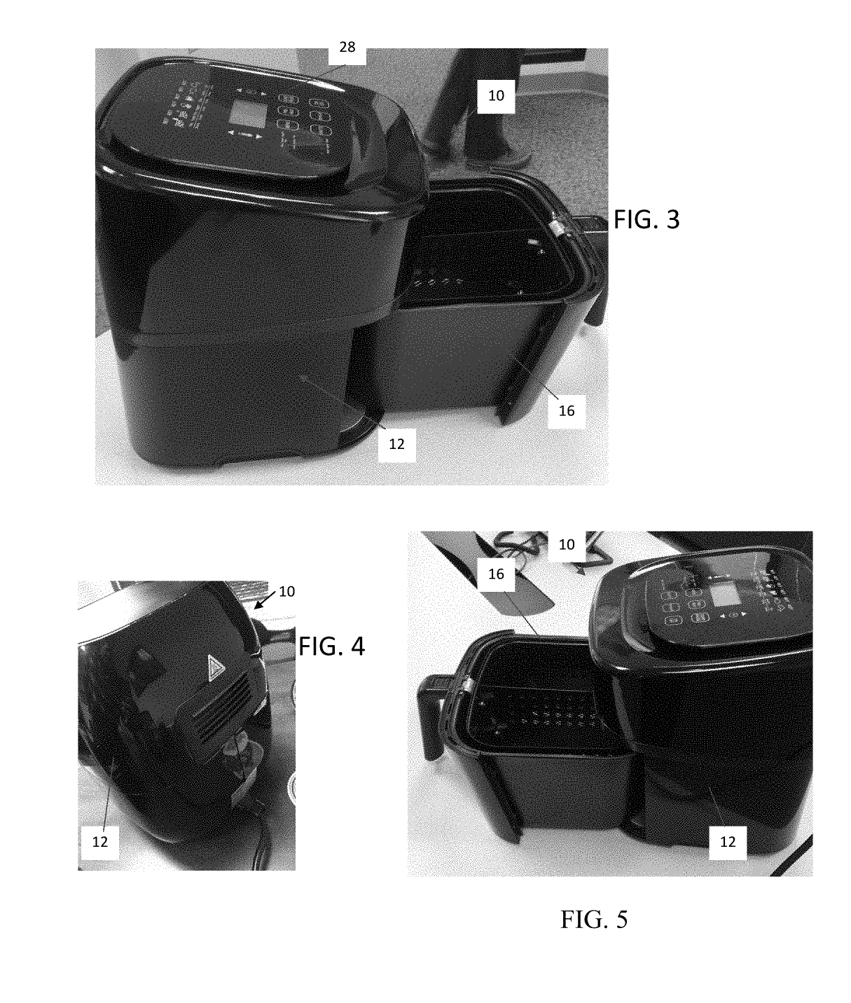

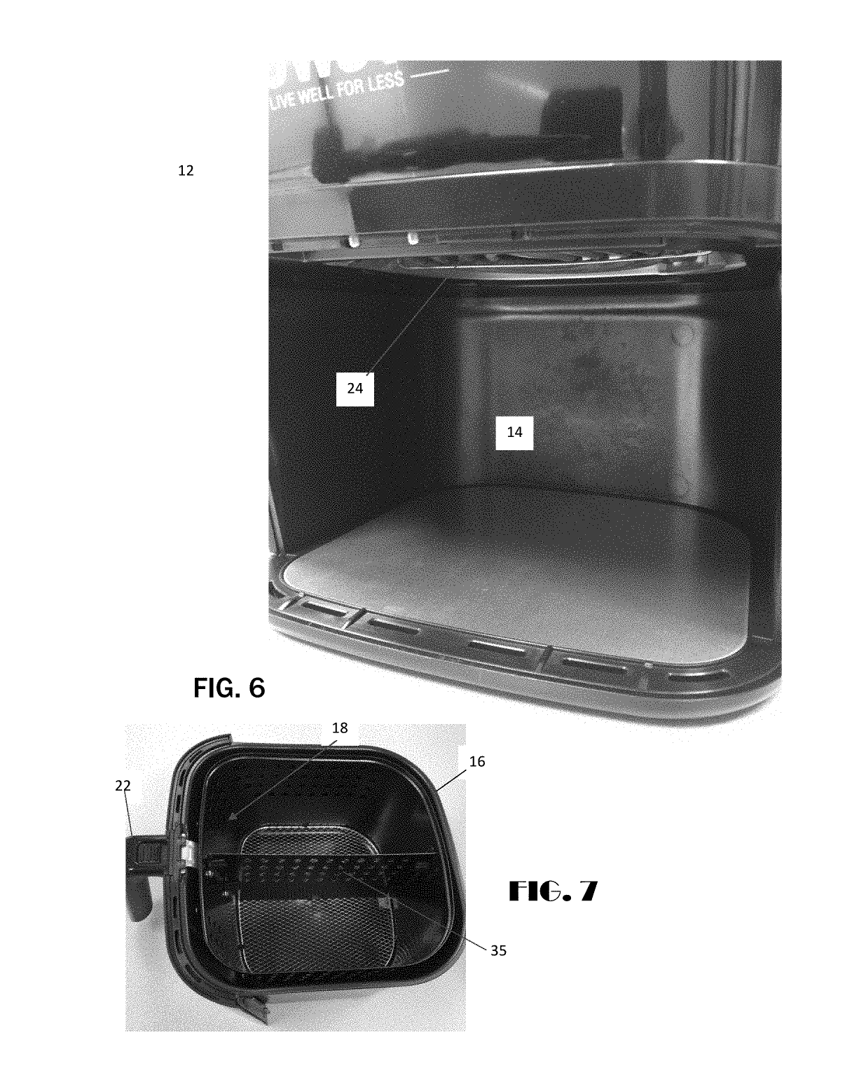

Referring to FIGS. 1-17, there are illustrated preferred embodiments, components and features of an air fryer, generally designated by the numeral 10. The particular illustrated embodiments of the air fryer 10 are for cooking with little to no oil using heated air. Further, while all the embodiments illustrated are directed to specific air fryers and features, it should be understood that the principles of the invention can be more broadly applied to numerous embodiments with changes made for specific applications without deviating from the intended scope of the invention.

As can be seen in FIGS. 1-16, the air fryer is comprised of several components. The disclosed air fryer includes a base unit 12 which houses a cooking chamber 14 into which a cooking drawer 16 is seated during use. The cooking drawer 16 supports a removable food basket 18 having a perforated container 20 and a handle 22. Also within the cooking chamber 14 is a heating source 24 and an air source 26, preferably a fan. An electric plug extending from the base unit 12 is used to plug into a standard AC outlet to provide power for the fryer.

As illustrated more clearly in FIGS. 14-15, a user interface 28 (e.g., touch controls) is provided on a face of the base unit 12. The interface 28 is preferably digital and may include a touch screen or push buttons 30, for example, a number pad, or “+” and “−” input buttons. The interface 28 may also include a plurality of programming buttons with preprogrammed inputs such as time, temperature, delay start, on/off, air speed (e.g., high, medium and low). Finally, LED indicators can be used illuminate current programs or functions operating and a display 32 will show time, temperature, and other programming features. The interface 28 may include both preset or preprogrammed buttons as well as programmable buttons. The preset buttons might cover a specified temperature for a period of time—e.g., 350° F. for 15 minutes—or a specific food item, such as “chicken” or “fish”. The programmable buttons would allow a user to create and store temperature and time for common personal food items. Preferably, the programmable buttons could be reset and/or altered, as desired.

A controller (not shown) makes the programmed operation of the system 10 possible. The controller may include both non-volatile and volatile memory for preset operations and programmable operations. The controller should also be coupled to control power to the heating source 24 and the air source 26. This allows the air fryer system 10 to automatically pause cooking if the drawer 16 is opened, as described below.

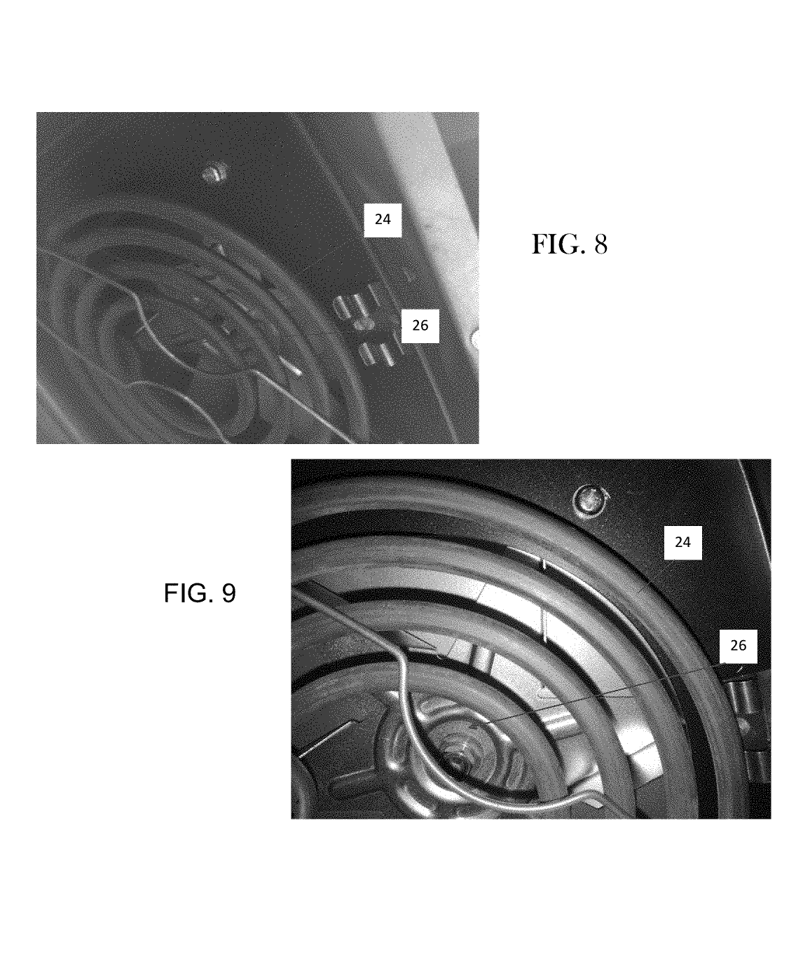

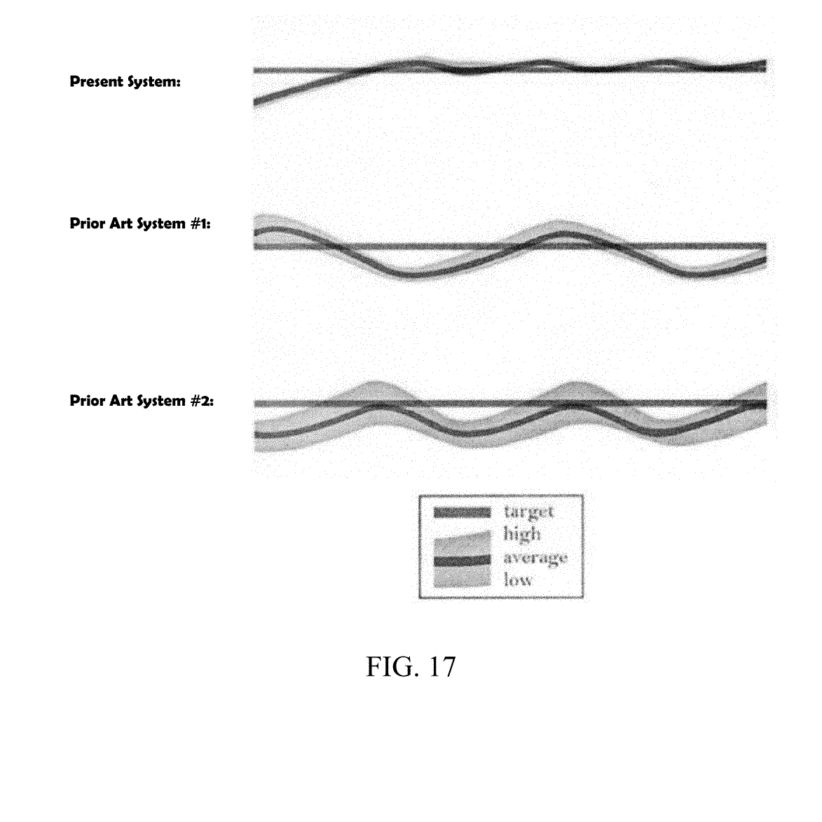

The heating source 24 (coil in FIGS. 8 and 9) and the air source 26 are positioned to operate within the cooking chamber 14. The heating source 24 is preferably positioned directly above the cooking chamber and includes an infrared heating element, as they are known to be more efficient than other heating elements. Alternatively, the heating source 24 may be a resistance heating element for limited uses. The air source 26, preferably positioned above the heating source 24, may be any suitable fan or several fans to keep air moving during the cooking process as shown in FIG. 17. The spaced placement of the two sources is one factor which allows for a more consistent temperature within the cooking chamber 14 as well as a more uniform distribution of heat throughout the cooking chamber 14. The consistent heat and even distribution feature provides a more reliable and thorough cooking of foods spaced throughout the cooking chamber 14, resulting in better quality cooked food.

The air fryer system 10 includes an automatic preheat feature. Instead of having to preheat to a set temperature, then once the temperature is achieved (usually ˜3-5 min) setting the time allotted for cooking,the current air fryer system 10 uses what is known in the industry as a “Touch-and-Go” process (from the NuWave Oven). The “Touch-and-Go” process allows a consumer to simply enter a time and temperature and the system does the rest automatically. The details of the NuWave Oven “Touch-and-Go” process are fully incorporated herein by reference.

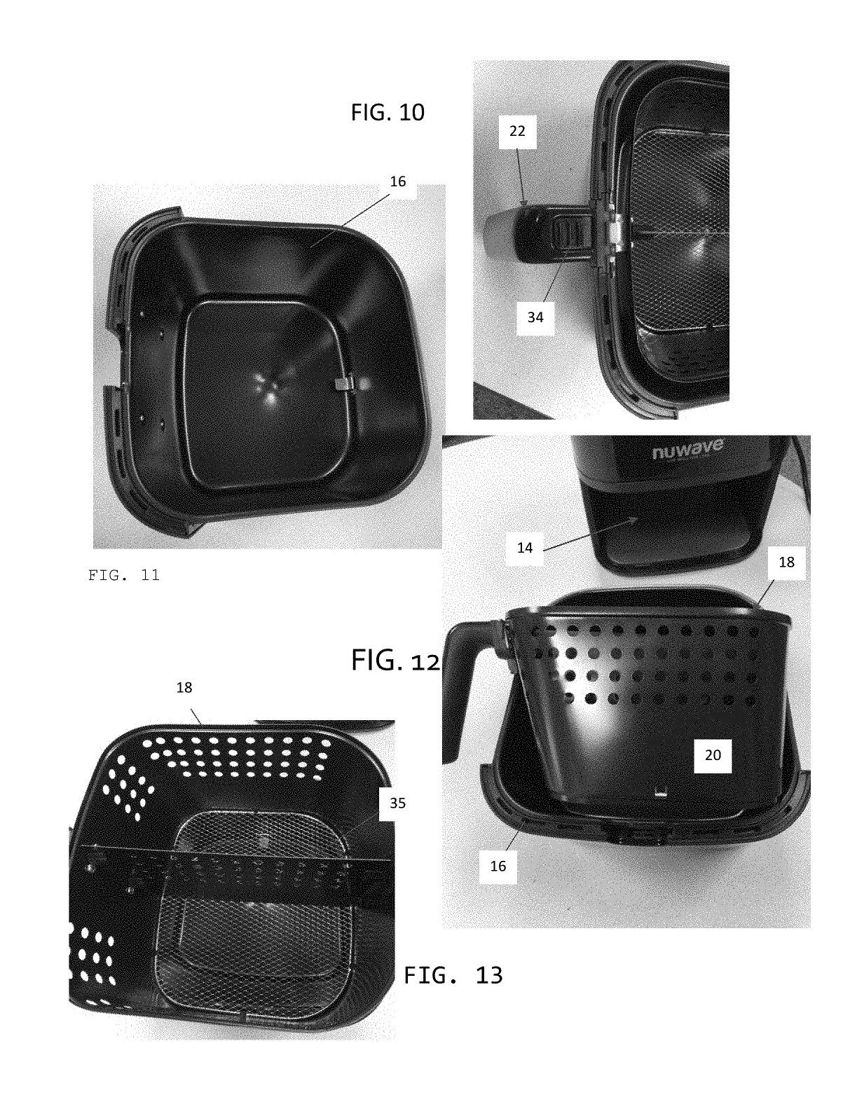

Referring to FIGS. 1-7, the cooking chamber 14 is fully occupied by the fitted cooking drawer 16. In a closed position, the drawer seals the chamber 14 to prevent the escape of heat. When opened, not only can the drawer 16 be completely removed from the chamber 14, but the food basket 18 can be removed from the drawer 16 as well. As shown in FIGS. 10-13, the drawer 16 supports a food cooking basket 18 having a handle 22 with a latch 34 which serves to lock the basket 18 into the drawer 16. The handle may also include a guard which protects against accidental unlatching of the basket 18. As previously mentioned, the system 10 includes a safety mechanism which will stop the heating source 24 and when the drawer 16 is not in a proper closed position. This mechanism is provided by a sensor (not shown) which determines an absence of or improper positioning of the drawer 16 within the cooking chamber 14. Either condition will cause the controller to immediately shut off the heating source 24. Heating may resume automatically when the drawer 16 is replaced, or heating commencement may require a user input. Those skilled in the art would be able to properly implement either safety feature.

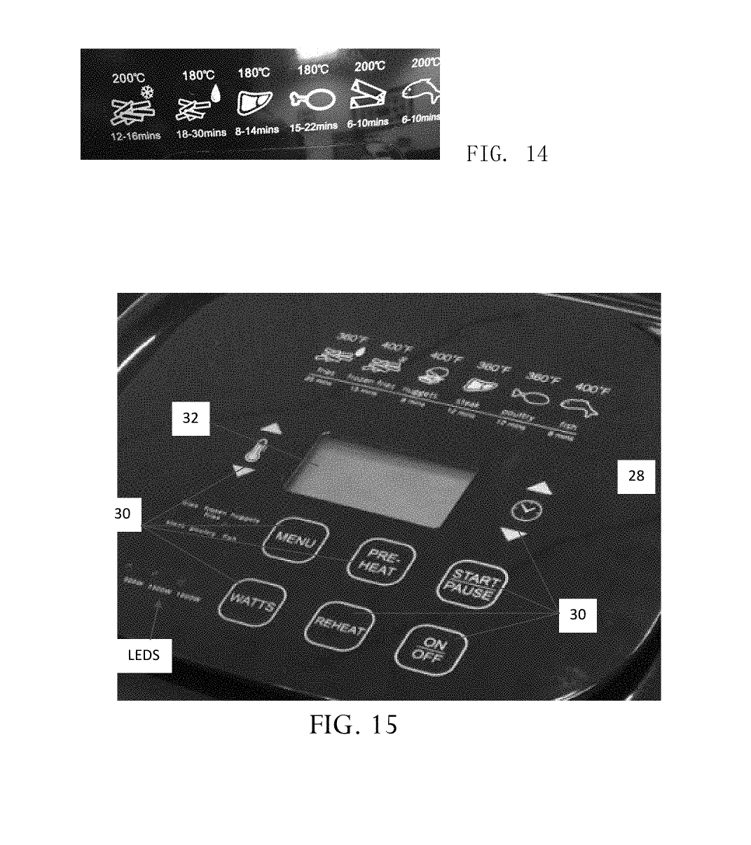

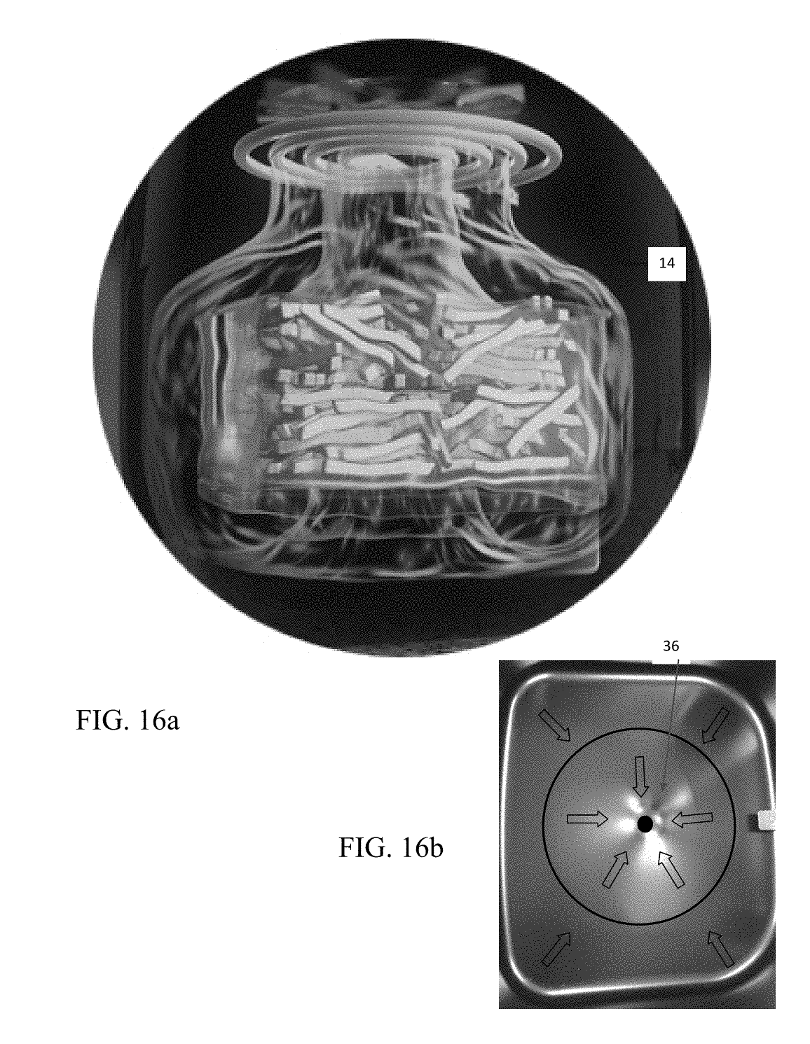

Another factor which contributes to the even distribution of heat in the cooking chamber 14 is the configuration of the food cooking basket 18 and drawer 16. Specifically, the drawer 16 includes a contour 36 on the bottom surface (see FIG. 16b) to direct heated air flow (as indicated by the arrows) and the basket 18 includes openings on all surfaces (see FIGS. 12-13) for directing heated air flow throughout the cooking chamber 14.

The contour 36 on the bottom of the drawer 16 is very much like an upside down cone. With reference to FIG. 16b, the large circle marks the perimeter of the wide part of the cone and the black dot at the center marks the apex of the cone. Air flows downward (outer arrows) from the air source 26 along the sidewalls of the drawer 16 and turn inward at the bottom surface. Then, at the perimeter (large circle), the air is directed upward (inner arrows) toward the apex, where it all meets and swirls through the food basket as shown in FIG. 16a.

The superior temperature consistency and evenness of the current air fryer system 10 is evidenced in FIG. 17. In the illustration, the heating consistency of the current air fryer system 10, referenced as “Current System”, is compared to two other air fryer systems—i.e., “Prior Art System #1” and “Prior Art System #2”. Temperatures were taken over a ten minute period from the respective cooking chambers of the three systems at four spaced locations. The high and low temperature readings during the period are represented by the wide undulating band for each system, with an average represented by the dark central line in the band. The target temperature is the straight line and represents the temperature set for each system. The “Current System” has a much smaller undulating “High” and “Low” band and clearly remains the most consistent at maintaining the target temperature once achieved.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

1. An air fryer system comprising:
a base having an outer surface, a heating source housed within, and an air source located therein, both the heating and air sources being supplied power for operation through a power source coupled to the base;
a cooking chamber defined within the base and configured to be effectively heated through operation of the heating and air sources;
a cooking drawer, a portion of which fits securely within the cooking chamber and a portion of which substantially seals the cooking chamber against heat loss during use;
a handled food basket which detachably connects to the cooking drawer such that the handle is outside the cooking chamber and the food basket is inside the cooking chamber when the cooking drawer is secured within the cooking chamber;
an electronic controller within the base for controlling at least the heating source, the air source and the power source; and
a user interface positioned on an outer surface of the base for inputting cooking parameters to the electronic controller.

2. The air fryer system of claim 1, wherein the food basket locks into the cooking drawer.

3. The air fryer system of claim 1, further comprising a divider positioned within the food basket.

4. The air fryer system of claim 1, wherein the heating source comprises an infrared source.

5. The air fryer system of claim 1, wherein the user interface comprises programmable time and temperature buttons.

6. The air fryer system of claim 1, wherein the user interface comprises a plurality of preset time and temperature settings.

7. The air fryer system of claim 1, wherein the user interface comprises a plurality of programmable buttons.

8. The air fryer system of claim 7, wherein the plurality of programmable buttons can be changed after programming.

9. The air fryer system of claim 1, further comprising a safety switch electronically coupled to the controller and configured to shut off the heating source when the cooking drawer is open.

10. The air fryer system of claim 1, wherein the controller maintains an average temperature within the cooking chamber within five degrees of a set temperature.

11. The air fryer system of claim 1, wherein the heating source and the air source are positioned within the base such that a temperature at any point within the cooking chamber is within five degrees of a set temperature.

12. An air fryer system comprising:
a base having an outer surface, a heating source, and an air source, both the heating and air sources being supplied power for operation through a power source coupled to the base;
a cooking chamber defined within the base and configured to be effectively heated through operation of the heating and air sources, wherein the heating source and air source are positioned within the base such that a temperature at any point within the cooking chamber is within five degrees of a set temperature;
a cooking drawer, a portion of which fits securely within the cooking chamber and a portion of which substantially seals the cooking chamber against heat loss during use;
a handled food basket having a divider and being detachably connected to the cooking drawer such that the handle is outside the cooking chamber and the food basket is inside the cooking chamber when the cooking drawer is secured within the cooking chamber;
an electronic controller within the base for controlling at least the heating source, the air source and the power source; and
a user interface positioned on an outer surface of the base for inputting cooking parameters to the electronic controller.

13. The air fryer system of claim 12, wherein the user interface comprises programmable time and temperature buttons.

14. The air fryer system of claim 13, wherein the user interface comprises a plurality of preset time and temperature settings.

15. The air fryer system of claim 14, wherein the user interface comprises a plurality of programmable buttons.

16. The air fryer system of claim 15, wherein the plurality of programmable buttons can be changed after programming.
